(19) United States
(12) Patent Application Publication
(10) Pub. No.: US 2016/0048291 A1
(43) Pub. Date: Feb. 18, 2016

(54) A CONTINUOUS + DISCRETE CONTROL MECHANISM COORDINATED WITH DECOUPLED OBJECT DISPLAY

(71) Applicant: REALITYGATE (PTY) LTD, Stellenbosch (ZA)

(72) Inventors: Hendrik Frans Verwoerd BOSHOFF, Stellenbosch (ZA); Willem Morkel VAN DER WESTHUIZEN, Stellenbosch (ZA); Jan POOL, Stellenbosch (ZA); Adri SMUTS, Durbanville (ZA)

(73) Assignee: REALITYGATE (PTY) LTD, Stellenbosch (ZA)

(21) Appl. No.: 14/780,144

(22) PCT Filed: Mar. 25, 2014
(86) PCT No.: PCT/ZA2014/000014

§ 371 Date: Sep. 25, 2015

(30) Foreign Application Priority Data
Mar. 27, 2013 (ZA) 2013/02285

(51) Int. Cl. G06F 3/0481; G06F 3/0484

(52) U.S. Cl. CPC G06F 3/04812; G06F 3/04842

(57) ABSTRACT

The invention provides a method, device and mechanism for human-computer interaction (HCI) on a graphical user interface (GUI). The method includes the steps of establishing a joint interaction arena (JIA) as a bounded connected subspace of the computing device's control space, establishing a Fused Threshold (FT) on the boundary of the JIA, establishing one or more interactive objects, establishing a relation between one or more of segments of the Fused Threshold and the object(s), displaying representations of at least two of the objects, receiving user input relative to the JIA and the FT, changing the JIA and/or the FT based on the user input whenever the relevant user input changes, and displaying the effect of the changes on the displayed objects.

### TECHNICAL FIELD OF THE INVENTION

This invention relates to a method for human-computer interaction on a graphical user interface.

### INTRODUCTION

Mouse methods different from the standard point-and-click mechanism have long been used to trigger some computer actions inside the conventional graphical user interface (GUI). Goal-crossing, i.e. causing a cursor to move beyond a goal or inside the boundary of some graphical interface object without clicking, is routinely used to navigate menu hierarchies, to create mouse-over effects and to activate hot corners. In a crossing-based interface (CBI) the objective is to enable the triggering of any desired action without the use of clicks. CBIs were analysed by Accot & Zhai [1]. Subsequently, Apitz worked with Guimbretière and Zhai to implement and test a complete crossing-based drawing application called CrossY [2, 3].

The experiments carried out by Accot & Zhai [1] involved a tablet and stylus, and in this context, they distinguish between continuous crossings, where “participants have to constantly slide the stylus tip on the tablet surface,” and discrete crossings, where “the stylus tip touches the tablet surface only when crossing the goal; the rest of the time the stylus is lifted from the tablet surface” [1, p 75]. Apitz et al [3] adopt the same continuous vs discrete crossing distinction.

The term threshold is used to describe a goal or boundary line whose crossing triggers discrete actions. Thresholds exist in control space, even though the cursor as an image of the user point and lines as images of the thresholds are displayed in display space to give the user feedback about their control actions.

The use of the adjective discrete in the context of actions is crucial here to specifically exclude continuous actions. Thresholds are inherently discrete. They take us from the continuous realm of geometry to the discrete realm of countable number. Thresholds serve either to discretize a continuum, or to increase the granularity of an already discrete set. Thresholds trigger discrete actions.

Despite having a continuous aspect, the application of animation is often a discrete action from this user centric viewpoint. If the animation is triggered by some user action, but then runs its course under computer control, it will be viewed as a discrete action. Continuous action remains under user control, ceases when user movement stops, and can be changed or reversed at any time.

Crossing a threshold may trigger one of three different effects involving respectively a single interface object (discrete change of the object state), two or more interface objects (discrete change of the relation between the objects) or something beyond the interface (discrete data operation). These possible effects will be collectively referred to as discrete actions.

Conversely, the appearance of any discrete and causal action or change in state or relation may lead to the question: what threshold-crossing triggered this? Examples of such discrete acts or changes associated with thresholds in other spheres of life, are going inside, coming of age, buying, going on a diet, getting married, switching on the air conditioning, etc.

A display line or border is often used to signal the existence of a control threshold to the user. However, when the cursor crosses the display border, it is as much an effect of the user point in control space crossing the control threshold, as the triggered action is such an effect. So border crossings in display space are effects, not causes, although the pixel grid of the display may be used as an important accounting device when the interaction involves control clutching or control-display ratio adaptation [4].

Should it seem that a display border triggers an action, it is an indication that an unnoticed control threshold has been established at the control position that is mapped to the relevant display border. The control action that causes the cursor to cross a display border, changes the cursor's display state e.g. from being outside an icon to being inside, indicating that the action associated with the icon may then be triggered by a click.

A threshold will always have one dimension less than the space in which it is placed. Thus a point can function as a threshold on a line, a line on a surface and a surface in a three dimensional space. Although often straight and flat, line and the surface thresholds may also be curved.

The metaphor of space has been used above, but a threshold may also be defined in relation to time or any other ordered set, like temperature, price, mass, degree of interest, etc. An electrical switch is based on one or more thresholds, and so is the discrete difference made between the tracking and non-tracking (out-of-range) states of an input device [5].

Thresholds may form boundaries between regions in control space. Crossing such a bounding threshold means the user point enters one region in control space and simultaneously exits another one. This is the model mostly followed by the traditional GUI.

Conversely, a segment of a line or a curve may be used as a threshold. Such finite thresholds do not (separately) define regions in control space. A finite threshold can be crossed repeatedly in the same direction, without any intermediate reverse crossing, by moving around one of its end points or edges. This is the model used in crossing-based interfaces.

A threshold may be said to appear in two different places depending on the direction in which it is crossed, creating hysteresis. This may be used to avoid jitter similar to a bistable multi-vibrator used in debouncing a switch. An alternative way of describing this same situation, is to say that there are two thresholds that are unidirectional in the triggering of their actions.

A control threshold may itself be moved interactively, in discrete steps or continuously, thereby advancing or postponing its crossing and therefore the action triggered by it. One example of this is performing the control action causing the dragging of a window edge in order to resize the window.

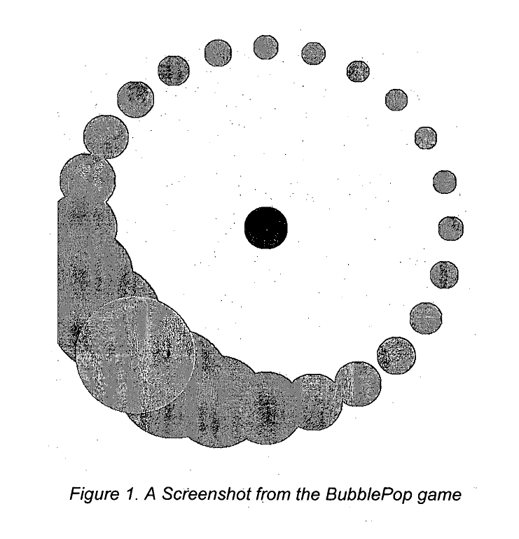

In a previous patent application by the same company, PCT/ZA2012/0000059 entitled: “Method for Human-Computer Interaction on a Graphical User Interface,” which is incorporated herewith in its entirety, an interaction style was introduced where a control trajectory is continuously interpreted and used to change object properties at a distance [6]. One of its examples refers to a simple game called BubblePop. See FIG. 1. A Screenshot from the BubblePop game.

The interaction in BubblePop (FIG. 1) is based on threshold crossings. A special geometric arrangement of the competing control thresholds is used, to prevent them from getting in each other's way. They appear side by side on a circle, leading to a layout that somewhat resembles a radial, pie or marking menu [7-10]. BubblePop may thus be viewed as a pie menu with discrete crossings, but with continuously changing visual object sizes.

The BubblePop game can be analysed from a crossing-based perspective, assuming the relation of the tablet and the finger to be initially out-of-range:
1. The user moves a finger to the small red disk displayed at the centre of the tablet surface, crossing a threshold when the finger touches the tablet. The tablet state changes to tracking, and the colour state of one randomly selected bubble on the circle changes to orange.
2. The user removes the finger from the tablet surface, crossing a threshold when the contact is broken. The tablet state changes to not-tracking, and the game is primed for another random bubble selection on the next contact.
3. The three steps may be repeated for another cycle.
4. While maintaining contact with the tablet, the user moves the finger radially away from the centre. The display size states of all the bubbles continuously change according to their distances from the finger, together with their positions in the buffer which determines their drawing order. Eventually, one of the bubbles' control thresholds is crossed. This triggers the popping action associated with that threshold, and the reporting of either a hit or a miss.

It turns out that three threshold crossings are needed for every bubble popped. The game can also be re-based to continuous crossings, reducing the crossings per pop to two, by having the user move back continuously to the central disk instead of breaking and making contact. On its own, the BubblePop style of interaction is best suited for repeated selection of one among N objects, where N is much larger than the eight or twelve items normally found in a pie menu, but less than about 120, depending on the size of the touch screen.

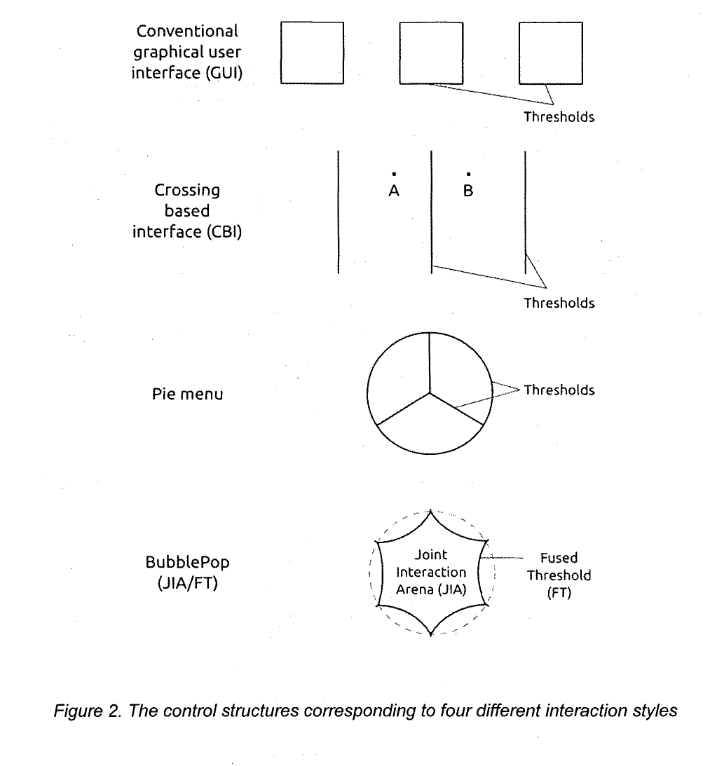

FIG. 2 shows the control structures for three well-known interaction styles (GUI icons, a CBI and a pie menu) in addition to BubblePop. Each case is illustrated with three items, except for the BubblePop case, which has six. The control thresholds are represented by lines congruent to those that would appear on the display, assuming no clutching. FIG. 2. The control structures corresponding to four different interaction styles

In the conventional GUI, the three piecewise linear thresholds divide the control plane into three rectangular bounded regions which are mapped to the displayed icons, and one large contiguous region outside, mapping to the canvas. The thresholds double as control region boundaries. When the button-down or button-up threshold is crossed during a pointing task, the most important question is: which display region contained the cursor? As long as the cursor can be linked to some display region at any given time, the crossing of the control thresholds separating the control regions is unimportant. In this sense the GUI is a region-based rather than a crossing-based interface, and an icon has the appearance of a control surface of a physical button or switch.

With the CBI, crossing-based interface, the three thresholds are straight and finite line segments that do not intersect. They therefore do not bound any regions, and the control plane remains a single contiguous unit. It is possible to go from point A to point B shown, either by crossing the threshold between them, or by avoiding it, going around its edges. In order to determine whether a threshold has been crossed, some of the user point history therefore has to be retained and interpolated.

The control structure for the pie menu may be created by joining together the three GUI control regions that are mapped to the icons, deformed and without gaps or overlap. There are three bounded inner regions, together covering a circular disk, and a fourth contiguous outside region. Every inner threshold is shared between two neighbouring regions, and the outer thresholds are circular segments. The display of the pie menu may be viewed as a single, compound, segmented icon. A pie menu is often used as a pop-up menu, placing it conveniently around the current user position in control space and around the cursor position in display space. This allows a very small user movement to establish the intended choice.

BubblePop shares some properties of CBIs, and others of pie menus. The BubblePop control structure shown in FIG. 2 may be created by fusing six finite CBI line segments without gaps or overlap (apart from the touch points), and then deforming them into a curve looking like a circle with bumps. This curve divides the plane into an inner and an outer region, and may be compared to the pie menu's outer threshold. Selecting or popping a bubble is triggered by crossing one of the curve's bumps. Which bubble pops depends on which part of the curve is crossed. The bumpy outer curve may thus be viewed as a single, compound or segmented Fused Threshold (FT).

However, nothing like the radial inner thresholds of the pie menu is shown in the BubblePop control structure. Even though radial lines co-determine the drawing sequence of the bubbles, they do not divide the inside of the control structure into regions each exclusively associated with a single item, as is the case with the pie menu. The inner region bounded by the Fused Threshold has been turned into a Joint Interaction Arena (JIA), in which any user movement is detected and used to simultaneously change the sizes of all the bubbles. Instead of having a separate controlling region for each item, there is a single joint region, controlling all of the objects at once. The objects are similar to spectators at a sports stadium, in that they focus on the action in the arena, respond to every meaningful movement, and in a sense, merge into a single beast.

All the points in control space mapped to the inside of a particular GUI icon or pie menu segment are treated the same. It does not matter to which exact pixel a control point is mapped, as long as that pixel falls somewhere inside a display item, the action associated with that item is triggered. In the new JIA region, however, every point is different, and in BubblePop the difference is reflected in the sizes of the objects. Priority (larger size) is given to the objects closer to the finger, and that priority is a continuous function that does not change discretely when radial lines are crossed.

Crossing the discrete FT is used to trigger discrete actions, and motion inside the continuous JIA is used primarily to control continuous actions. The combination can therefore be characterized as a single continuous+discrete control structure.

If the JIA is simplified to a circular disk, an arbitrary user point inside the arena can be connected to every point on the FT, without any of the connecting lines crossing. In contrast to the crossing-based interface, none of the thresholds can obstruct any of the other. From any user point inside such a JIA disk there is a unique straight line to every point on the FT, including those FT points representing objects. This is independent of the number of objects. This property will be conserved under deformation of the JIA, as long as it remains star-convex with respect to the user point.

The bubbles themselves are not indicated in FIG. 2. They are displayed outside the image of the FT curve, an image that is not even displayed during the game. This absence of direct feedback on the position of the control threshold, is an example of separation between control and display. Such separation is associated with distortion viewing, and is not normally found in GUIs, crossing-based interfaces, or pie menus.

The current GUI approaches are all object oriented in the sense that user input is interpreted, after being mapped to display space, in relation to the displayed interface objects. A visible border surrounds every object, and the border doubles as the image of the control threshold associated with that object. This approach is both simple and familiar, but it is wasteful of user input. Since the control points mapped to the pixels inside the object border are all treated the same, very little response is shown to pointer movement, until the user issues a click. On the other hand, the current CBI approaches dispense with the need for a click, but the interface is still mostly inert, and the thresholds may obscure each other. Thus there remains a need in the art for a method of interaction that makes maximum use of the information available from tracking user movement in control space, and that may therefore be characterized as user oriented. One way in which this may be achieved is by making full use of the Joint Interaction Arena and the Fused Threshold, as foreshadowed in the BubblePop game.

### REFERENCES

[1] Johnny Accot and Shumin Zhai, “More than dotting the i's—foundations for crossing-based interfaces,” Proc. SIGCHI Conf. CHI '02, 2002, pp 73-80.

[2] Georg Apitz and Francois Guimbretière, “CrossY: a crossing-based drawing application,” Proc. 17th ACM symp. (UIST '04), 2004, pp 3-12.

[3] Georg Apitz, Francois Guimbretière, and Shumin Zhai, “Foundations for designing and evaluating user interfaces based on the crossing paradigm,” ACM Trans. Comput.-Hum. Interact. 17, 2, Article 9 (May 2008), 42 pp.

[4] Renaud Blanch, Yves Guiard and Michel Beaudouin-Lafon, “Semantic Pointing: Improving target acquisition with control-display ratio adaptation,” CHI Letters, Vol. 6 No. 1, 2004, pp 519-526.

[5] William Buxton, “A Three-State Model of Graphical Input,” In D. Diaper et al. (Eds), Human-Computer Interaction—INTERACT '90, Amsterdam: Elsevier Science Publishers B.V. (North-Holland), 1990, pp 449-456.

[6] Patent application no PCT/ZA2012/0000059 entitled: “Method for Human-Computer Interaction on a Graphical User Interface.”

[7] Don Hopkins, “Theta Menus Proposal and Pie Menu Designs,” http://www.donhopkins.com/drupal/node/82, accessed 18 Jun. 2012, 1986

[8] Jack Callahan, Don Hopkins, Mark Weisert and Ben Shneiderman, “An empirical comparison of pie vs linear menus,” Proc. ACM CHI '88, 1988, p 95-100.

[9] Krystian Samp, “The design and evaluation of graphical radial menus,” PhD thesis, National University of Ireland, Galway, 2011, 180 pp.

Gordon Kurtenbach and William Buxton, “The limits of expert performance using hierarchic marking menus,” Proc. Conf. CHI, 1993, pp 482-487.

### GENERAL DESCRIPTION OF THE INVENTION

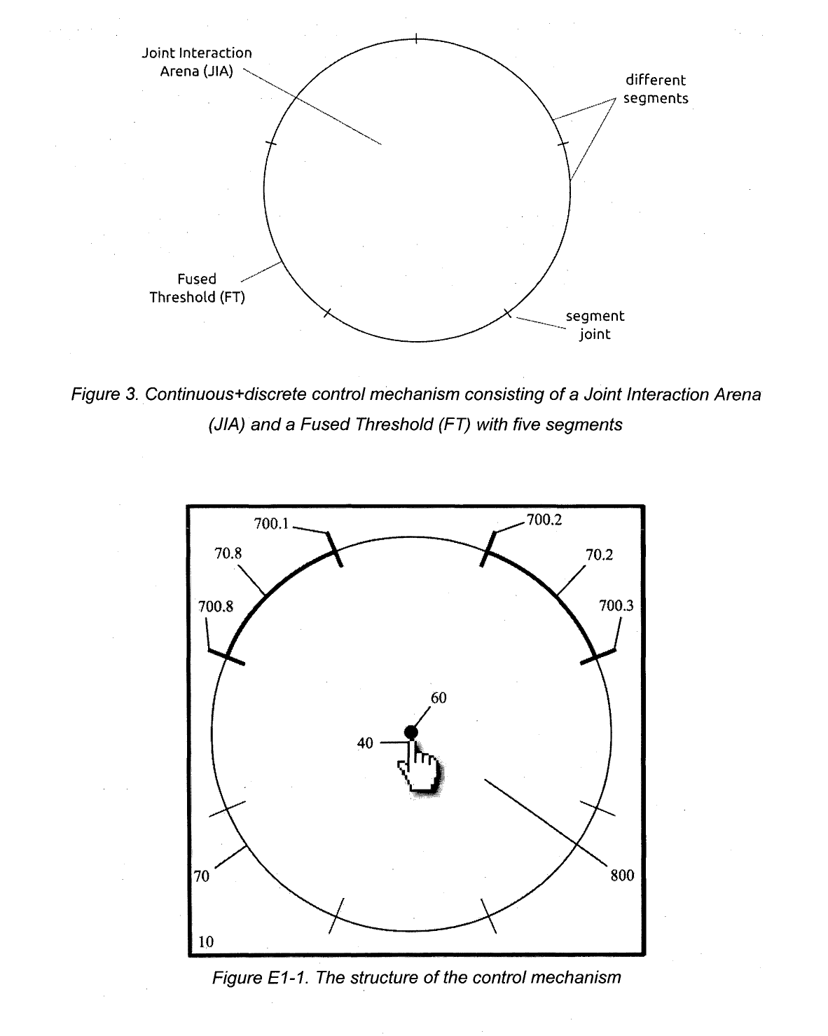

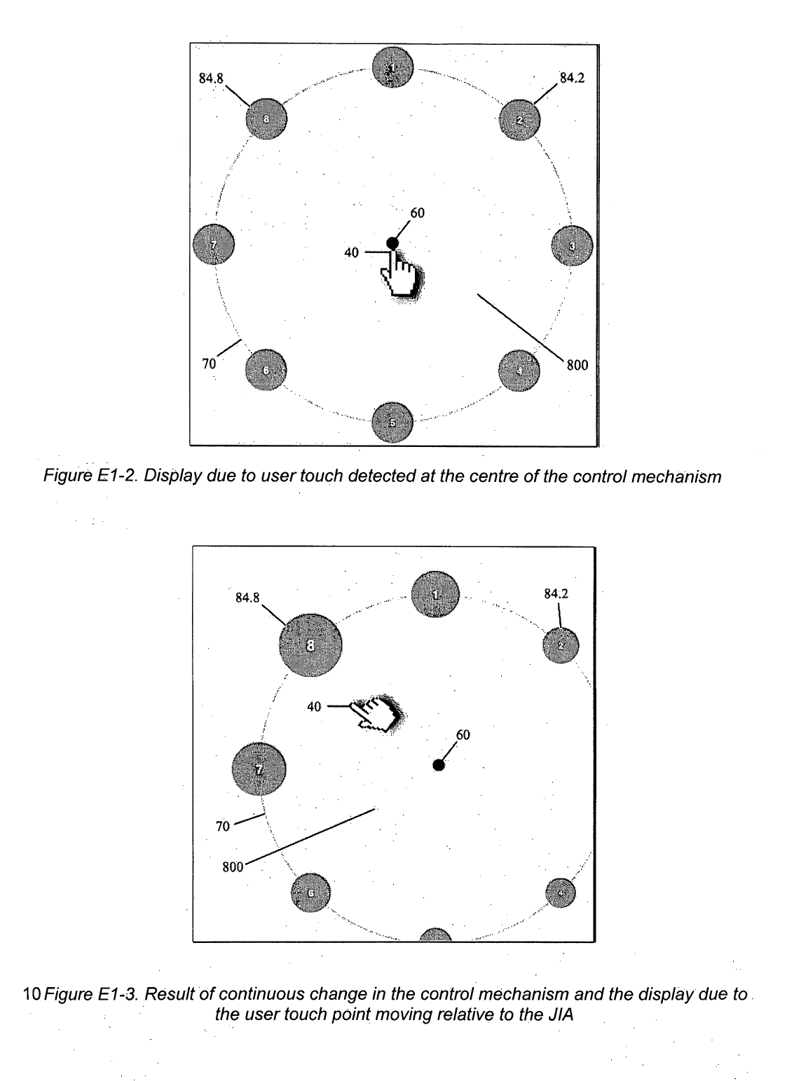

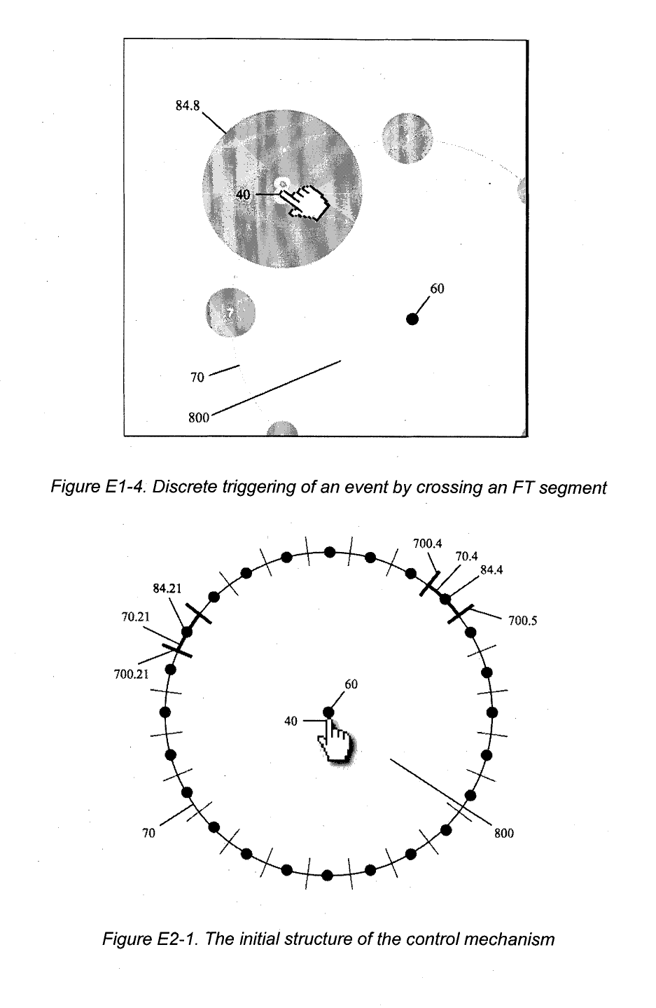

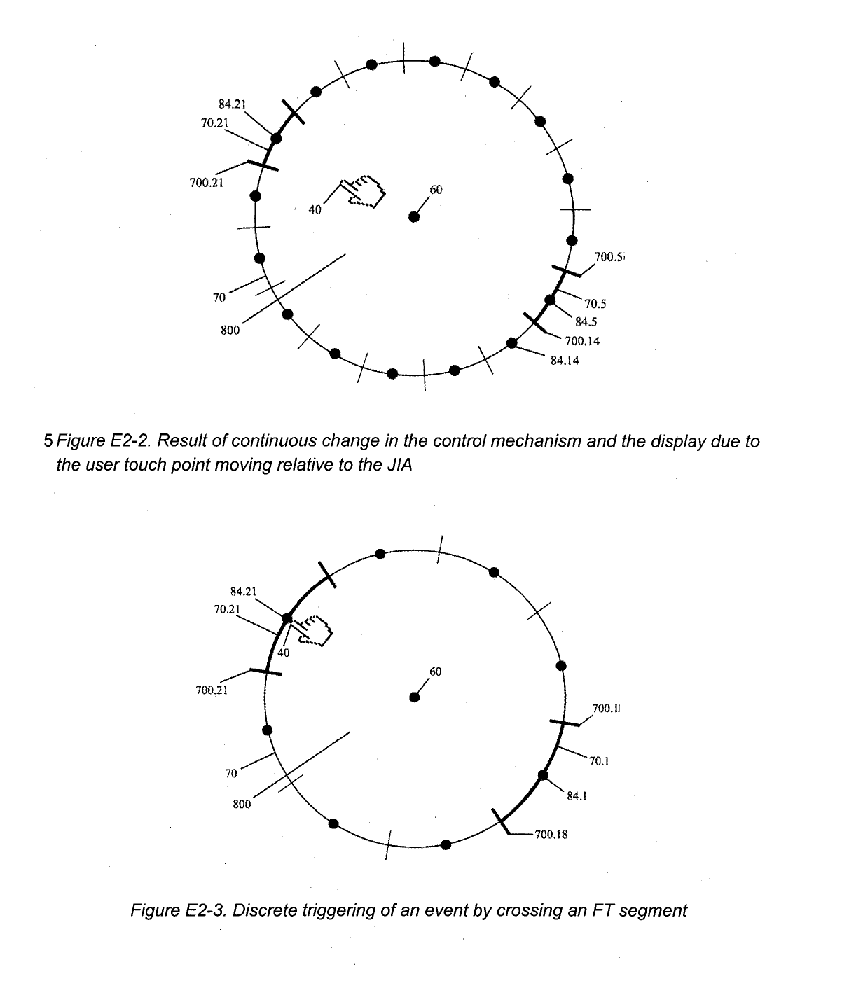

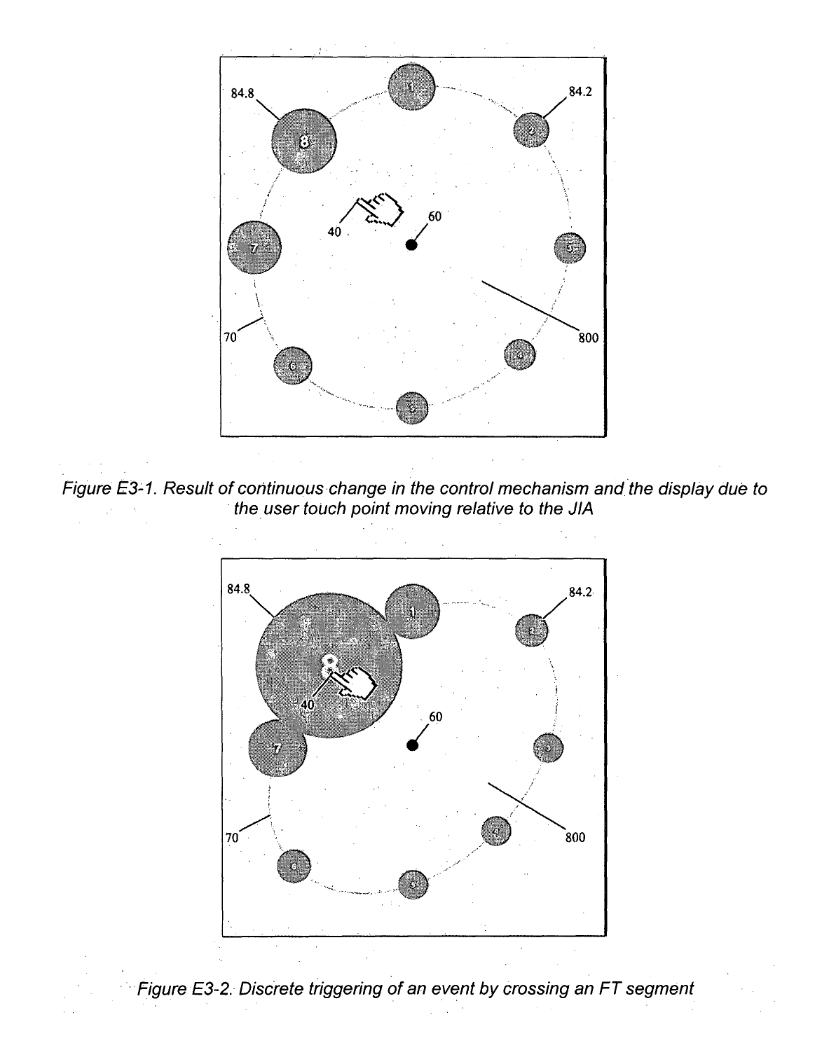

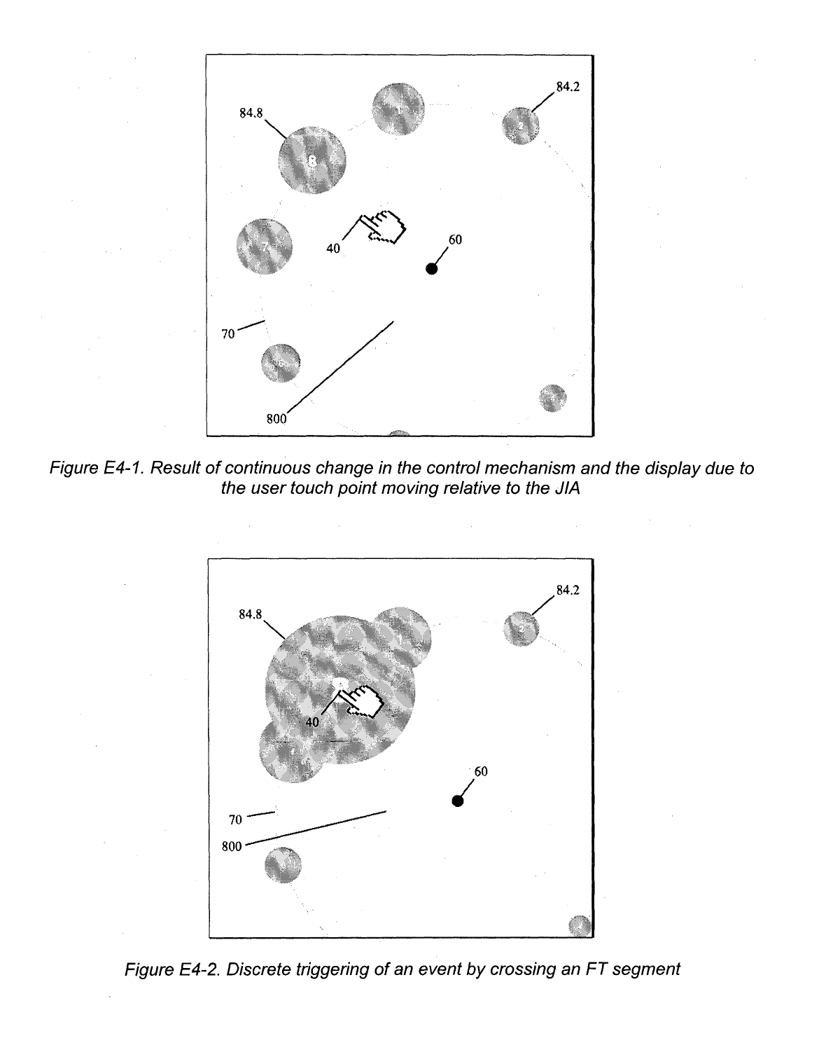

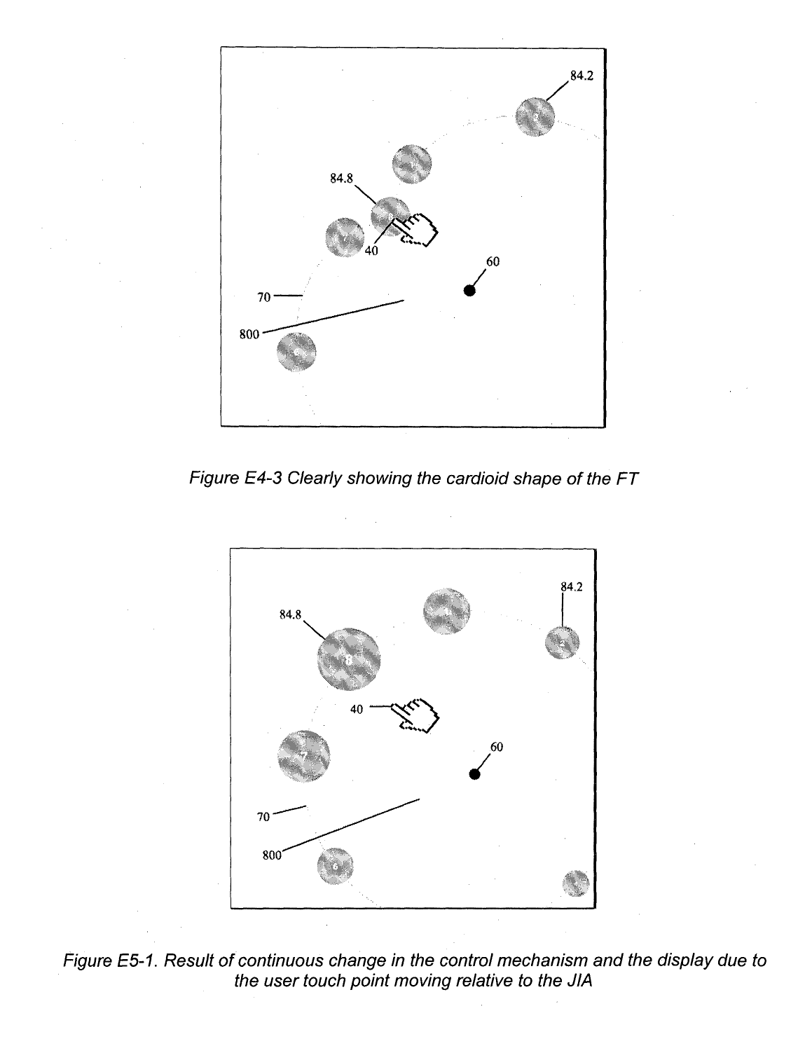

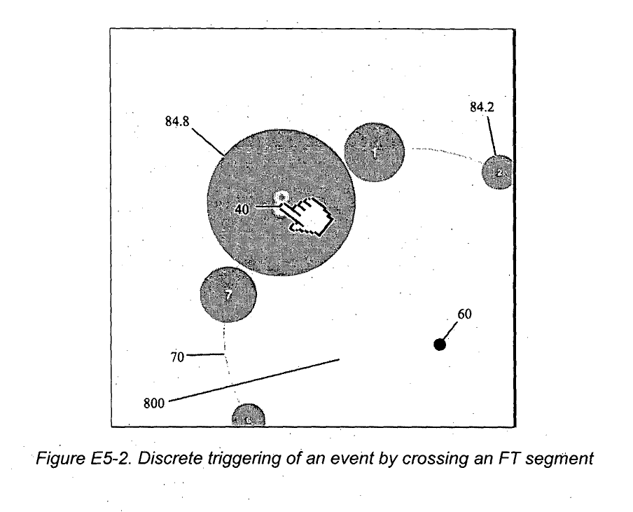

The present invention combines the use of both thresholds and spaces for control purposes. Continuous control calls for an augmentation of the threshold-based control structure (the Fused Threshold, or FT) with a continuous spatial part (the Join Interaction Arena, or JIA). A single joint continuous+discrete control mechanism is thus created, as shown in FIG. 3. The JIA and the FT are two necessary and complementary parts of a single geometric control structure. A bounded space must be bounded by a closed surface, and a closed surface always encloses a bounded space. Defining the one necessarily implies the existence of the other. The JIA is the bounded space and the FT is its bounding surface. See FIG. 3. Continuous+discrete control mechanism consisting of a Joint Interaction Arena (JIA) and a Fused Threshold (FT) with five segments.

The JIA and the FT bounding it may not seem much in their BubblePop guise. However, two types of extension are possible to what has been presented so far. Firstly, new effects may be based on user movement inside the WA and on the user point crossing the FT, where the shape of the FT is still being kept static. Secondly, the user movement inside the JIA may be interpreted to change the rules for using the JIA itself or to change the shape of the FT. In this second case, positive feedback has to be avoided to maintain stability and user control. The two extensions build on the properties of the JIA and the FT, which properties can be summarized as shown below.

### The Joint Interaction Arena (JIA):

is a bounded connected subspace of the interaction control space

is bounded by the Fused Threshold (FT)

is used primarily to control continuous actions

may be augmented with thresholds to trigger discrete actions

may preferably be simply connected and star-convex

may be combined with memory for hysteresis effects

may be used to move the FT

may be used to change the FT shape, and therefore, itself indirectly

may be used to change the rules for its own use, changing itself reflexively.

### The Fused Threshold (FT):

is a closed curve or surface bounding the JIA

has a dimension one lower than that of the interaction control space

makes a binary division of the space into the inside (JIA) and the outside

spatially represents information on interactive objects in its segments

is used to trigger discrete actions when crossed

may be used to change the rules for using the JIA

can be moved, scaled or rotated as a whole (changed)

can be deformed (changed)

can have its set of fusion joints shifted, added to or removed from (changed)

may be used to reflexively trigger a change in its own shape.

Triggering actions with the help of thresholds is what crossing based interfaces, CBIs, are all about. But doing things with thresholds as the source of actions is quite different from doing things to thresholds, where they become the target of the actions, even as they remain the source, resulting in reflexive meta-actions.

The above three listed ways in which the FT can be changed have a profound effect on how it functions during interaction. In addition, whether the whole FT is moved continuously or in discrete steps, makes a significant difference. Continuous deformation is one way of implementing cooperative targets, and the shifting of fusion joints enable dynamic reallocation of the control space, also known as providing an advantage in motor space to some control task. It is important to realize that control space is conserved, and that increasing the advantage in motor space of one task invariably decreases that of others.

One form of coordination between separated control and display elements, is an overlap in the range of directions from the user point and cursor in the control and display spaces, respectively, to the extreme points of the control and display elements, respectively.

In summary, the present invention is based on the continuous+discrete control mechanism shown in FIG. 3. Each segment of the FT threshold is associated with some object. Continuous interaction takes place inside the JIA disk and dynamic object display is typically done outside the circle, with a close relationship between the two. The space of the JIA is opened up for the joint creation of a trajectory by the user and the computer, while both the objects and the control mechanism itself may be transformed in the process. A discrete change or action is only triggered once the user point reaches the FT circle.

According to the invention there is provided a method for human-computer interaction (HCI) on a graphical user interface (GUI), including the steps of:
establishing a joint interaction arena (JIA) as a bounded connected subspace of the computing device's control space;
establishing a Fused Threshold (FT) on the boundary of the JIA;
establishing one or more interactive object(s);
establishing a relation between one or more of segments of the Fused Threshold and the objects;
displaying representations of at least two of the objects;
receiving user input relative to the JIA and the FT;
changing the JIA and/or the FT based on the user input whenever the relevant user input changes; and
displaying the effect of the changes on the displayed objects.

The JIA may be changed by changing any one or more of its position, shape and rules for its use.

The FT may be changed by moving, scaling, rotating the FT as a whole. The FT may further be deformed. The FT may also be changed by shifting or changing its fusion joints or by adding or removing fusion joints.

The bounded subspace of the JIA may be limited to a star shape with respect to the user point, throughout the interaction.

The method, in the step of changing the JIA and/or the FT and/or the display based on the user input whenever the relevant user input changes, may include the following step:

interpreting the user input in a way that takes into account user movements at earlier instants in time.

The method, in the step of changing the JIA and/or the FT and/or the display based on the user input whenever the relevant user input changes, may include the following step:

interpreting the user input in a way that predicts future user movements.

The method, in the step of changing the JIA and/or the FT and/or the display based on the user input whenever the relevant user input changes, may include the following step:

interpreting the user input in a way that reflexively changes the way in which user input is interpreted.

It will be understood that a star shaped object is also known as a star domain, a star-convex set or a radially convex set.

It will further be understood that an important property of a star shaped object is its contractibility, i.e. that it can be continuously shrunk to a point. A contractible object may easily be made cooperative with user input by asymmetric contraction in the direction of user movement, while associating a unique direction with every interactive item mapped to the boundary of the contractible object.

The JIA will preferably be a simply connected set, that is, it will consist of one piece without holes in it.

An object may also represent an action, e.g. an icon may stand for playing a song, editing a file or sending an email.

User input is often interpreted to determine the position of a cursor or pointer in the display space or a user point in the control space associated with the input device.

Further, the JIA will have the same dimensionality as the control space. The boundary of a space always has one dimension less than the space it bounds, so that the FT will have one dimension less than the control space. For example, on a tablet the JIA will be a contiguous area, while the FT will be the line surrounding the area.

In the case of a two dimensional control space, a simple shape of the FT may be a circle and the associated JIA will then be the disk enclosed by the circle.

The movement of the user point can be tracked to form a user trajectory in the control space. The user trajectory thus describes the history of the user point. Such a user trajectory can easily remain within the JIA, but will cross the FT when reaching it, unless the FT also bounds the control space.

Therefore, with respect to the user trajectory, the JIA has the property of being virtually continuous, but the FT in contrast is discrete.

Further, the interpretation of user input with respect to the JIA can be either continuous or discrete, the latter interpretation will need the introduction of one or more thresholds inside the JIA. In contrast, the interpretation of user input with respect to the FT can only be discrete.

It will thus be appreciated that the JIA and the FT together form a continuous+discrete control mechanism.

The JIA and the FT can both be part of the source of user control, by interpreting user movements with respect to their geometry. The target of control may be the objects, as is usual in HCI, but in the current method the targets may also include the JIA and the FT themselves. This means that the method may be reflexive in that the source and the target of control can both include the same thing.

In the step of establishing a relation between the FT segments and a plurality of objects, a simple example relation is where the FT segments and the objects share the same radial direction or a range of directions.

The JIA+FT control mechanism need not necessarily be visible. In the case of an invisible control mechanism, the dynamic object display afforded by the method may be used to ensure that the user comprehends the causal relationship between control and display during the interaction.

The user input may be received from an input device capable of sensing three dimensional movement. In such a case, the WA will be a bounded portion of three dimensional space, while the FT will be the surface bounding it.

The conventional GUI control thresholds are primarily associated with objects, typically surrounding them and mapping to their display boundaries. There are therefore a plurality of closed thresholds arranged in an object oriented way. In contrast, with the JIA+FT method, the multiple thresholds are separately open, but jointly closed in the form of the FT, and the FT surrounds the user point. In this sense the thresholds in the JIA+FT method are arranged in a user oriented way, and they are fused into a single combined object responding coherently to user input. Even if there were gaps on the JIA boundary not covered by FT segments, they are still constrained by the boundary as a closed surface.

It will be appreciated that in the conventional GUI, the control and display of objects are tightly coupled, to the point where the user is likely not to distinguish between them. In the JIA+FT method on the other hand, a limited decoupling of the control space representation and the display space representation of each object is allowed. The step of establishing a relation between FT segments and objects is thus needed to ensure a coordination or coherence between control and display that is intuitively intelligible to the user during dynamic interaction.

More than one control mechanism of the sort described in the JIA+FT method may be established inside the same control space. In such a case, interaction between the mechanisms may be enabled.

Direct interaction in HCI is often based on an imitation of physical interactions, including forces like electrical, magnetic and gravitational attraction and principles like conservation of momentum. In such a setting, mutually reinforcing effects like cooperative movement may easily lead to positive feedback and the resulting loss of control. In the JIA+FT method, the meta-effects of cooperative movement are not implemented, in order to avoid positive feedback. Thus a cessation of user movement may result in an immediate cessation of object movement on the display, despite the use of strong mathematical functions selected to enhance user action.

The JIA and the FT are so closely interconnected that they may be regarded as two ways to describe the same geometrical structure. Specification of a bounded subspace amounts to a specification of its boundary, and conversely specification of a closed boundary amounts to a specification of the space bounded by it. Therefore the current method's restriction of the FT to be on the boundary of the JIA may not be simply circumvented by placing the FT off but near the boundary. The extent of the JIA is defined by the position of the FT, and moving the FT actually changes the JIA.

A bounded space may be divided into parts by a set that is not closed. Thus a line segment may divide a rectangle into two parts. When the boundary of the JIA seems to be open, the current method regards at least a subset of the boundary of the control space itself as constituting a subset of the JIA boundary as well, which may always be selected in a way that the JIA boundary is once again closed. Thus the method should not be understood to require the segments of the FT to collectively cover the whole boundary of the JIA.

It will be appreciated that the boundaries of the display space are in general easier to determine than the boundaries of the control space, especially in the case of indirection. Should the boundedness of the control space be a problem for establishing the JIA, the inverse of the computing device's C-D function connecting the control space to the display space can be used to derive bounds for the control space from the bounds of the display space.

The invention also relates to a device for human-computer interaction (HCI) on a graphical user interface (GUI), including:
a joint interaction arena (JIA) as a bounded connected subspace of the computing device's control space;
a Fused Threshold (FT) on the boundary of the JIA;
wherein a relation between the FT segments and a plurality of objects is established;
displayed representations of at least two of the objects;
a user input space for receiving user input relative to the JIA and the FT; and
wherein the device is configured to change the JIA and/or the FT and/or the display based on the user input whenever the relevant user input changes.

The invention also relates to continuous-discrete control mechanism, wherein the continuous part of the mechanism is configured to:
establish a joint interaction arena (JIA) as a bounded connected subspace of the computing device's control space;
   establish a Fused Threshold (FT) on the boundary of the JIA;
   establish one or more interactive objects;
   establish a relation between one or more of segments of the Fused Threshold and the objects;
   display representations of at least two of the objects;
   receive user input relative to the JIA and the FT;
   change the JIA and/or the FT based on the user input whenever, the relevant user input changes; and
   display the effect of the changes on the displayed objects;
and wherein the discrete part of the mechanism includes activating an action once the FT is crossed by a user.

### DETAILED DESCRIPTION OF THE INVENTION

The invention is now described by way of examples with reference to the accompanying drawings wherein:

FIG. E1-1 shows the structure of a control mechanism;

FIG. E1-2 shows the display due to user touch detected at the centre of the control mechanism;

FIG. E1-3 Shows the result of continuous change in the control mechanism and the display due to the user touch point moving relative to the JIA;

FIG. E1-4 Shows discrete triggering of an event by crossing an FT segment;

FIG. E2-1 shows the initial structure of a control mechanism;

FIG. E2-2 shows the result of continuous change in the control mechanism and the display due to the user touch point moving relative to the JIA;

FIG. E2-3 shows discrete triggering of an event by crossing an FT segment;

FIG. E3-1 shows result of continuous change in the control mechanism and the display due to the user touch point moving relative to the JIA;

FIG. E3-2 shows discrete triggering of an event by crossing an FT segment;

FIG. E4-1 shows a result of continuous change in the control mechanism and the display due to the user touch point moving relative to the JIA;

FIG. E4-2 shows discrete triggering of an event by crossing an FT segment;

FIG. E5-1 shows a result of continuous change in the control mechanism and the display due to the user touch point moving relative to the JIA; and

FIG. E5-2 shows discrete triggering of an event by crossing an FT segment.

### EXAMPLE 1

### Moving the Centre of the Control Mechanism

In this first example of the invention, the method for human computer interaction (HCI) on a graphical user interface (GUI) is used reflexively to move the centre of the control mechanism itself, thereby speeding up the process of interaction. The method includes the step of establishing a joint interaction arena (JIA) as a bounded subspace of the computing device's control space. The computing device in this example is a tablet, where the control space (touch area) and the display space (screen area) are tightly integrated to form a single touch screen. FIG. E1-1 depicts the control space 10, and the circular line 70 can be seen to enclose the area of a disk. The centre 60 of both the circle and the disk is indicated by a black dot. The disk, which is a subspace of the control space 10 and which is bounded by the circle 70, is established as the JIA 800. When the user touches a point inside the JIA 800, it will have a joint interaction effect on the objects to be introduced.

The method also includes the step of establishing a Fused Threshold (FT) on the boundary of the JIA. The circle 70 forming the boundary of the JIA 800 is divided in this example into eight contiguous and non-overlapping segments 70.i, where i ranges from 1 to 8. The segments 70.2 and 70.8 are explicitly labelled in FIG. E1-1. The eight segments 70.1 to 70.8 together form the FT 70, which is graphically indistinguishable from the circle 70. The JIA 800 and the FT 70 together form a single JIA+FT control mechanism.

The joints 700.i between the segments are also shown, with the joints 700.2, 700.3, 700.8 and 700.1 explicitly labelled. In this example, the segments are all contiguous. If any two neighbouring segments were not contiguous, edges on both sides of the gap separating them would replace the currently shared joint.

The method also includes the step of establishing a relation between the FT segments and a plurality of objects. Each of the eight FT segments 70.i in this example is associated with a data object represented in the computer memory. These data objects may for example be files containing images, text, music or programs. The objects may therefore also represent actions like playing a song or editing a document. The association in this example is a one to one relation between the FT segments 70.i and the data objects.

The method also includes the step of displaying representations of at least two of the objects. FIG. E1-2 shows eight numbered grey discs 84.i which are representations of eight objects. This figure depicts a combination of the control space and the display space which are integrated in the example device. The control space is mapped linearly to the display space. The mapped FT is shown as the circle 70 and the mapped JIA as the disk 800.

Each object representation 84.i in this example is positioned in the middle of the corresponding mapped position of FT segment 70.i, illustrating a relation where the control element 70.i and the display element 84.i share the same radial direction. The geometric relations between the control and display elements related to the same object need not always be as strict as in this simple example, but the user must be able to intuitively comprehend the relations as the interaction progresses. The exploration of cause and effect during continuous interaction aids such comprehension.

The method also includes the step of receiving user input relative to the JIA and the FT. The user input in this example is the point of touch 40 on the touch screen 10 at any instant in time. The point of touch 40 is then interpreted in a continuous way with respect to the JIA 800, but in a discrete way with respect to the FT 70.

The continuous interpretation of the user input 40 with respect to the JIA 800 in this example involves continuous changes in the sizes of the object representations 84.i, and a reflexive continuous change to the single JIA+FT control mechanism itself. The discrete interpretation of the user input 40 with respect to the FT 70 involves triggering the action associated with the object 84.i, when the user touch point crosses the FT 70 at segment 70.i.

The method also includes the step of changing the JIA and/or the FT and/or the display whenever the relevant user input changes. In this example, all three the mentioned elements are changed. FIG. E1-2 shows the display space 14 of the device, when it is configured with eight segments and eight objects, and the user touch point 40 is at the centre point 60 of the JIA+FT control mechanism.

When the user touch point 40 moves in the general direction of object 84.8, two effects can be observed, as shown in FIG. E1-3. Firstly, the display sizes of all the objects have changed, with 84.8 growing and 84.4 in the opposite direction shrinking, and the rest interpolating the effect. Secondly, the FT 70 and the JIA 800 have moved in the opposite direction to the user touch point 40, resulting in a move of the centre 60 of the JIA+FT control mechanism relative to the screen or display space.

Note that the JIA+FT control mechanism itself is not necessarily displayed. When properly implemented, as in an option of the app in this example, the user perceives the effect of the invisible control mechanism indirectly via the dynamic display of object representations, with no loss of clarity or control.

The changes in both the display and control result from continuous interaction between the user touch point 40 and the JIA 800. The possibility of positive feedback during continuous interaction is avoided by implementing the effect of moving the touch point 40 on the centre 60, but no second order effect of the movement of the centre 60. The method may be said to implement a first order effect, but not to simulate a force that can have second order effects, like electrical or gravitational attraction.

FIG. E1-4 illustrates the discrete interaction between the user touch point 40 and the FT 70. It shows the instant where the user touch point 40 has reached the segment 70.8 associated with object 8, triggering its associated action. Note that the centre of the display representation need not coincide with the corresponding segment as shown here. Something else like the edge of the display circle may be mapped to the segment.

This example shows that the method can be used to translate or move the centre of a circular JIA+FT control mechanism. It is also possible to use the method to similarly scale or change the radius of the control mechanism, thereby adding a dynamic effect that will further speed up interaction.

### EXAMPLE 2

### Moving the Joints of the Fused Threshold

In the second example of the invention, the method for human computer interaction (HCI) on a graphical user interface (GUI) is used to move the joints on the fused threshold of the control mechanism, thereby providing control of the allocation of motor space to objects. The method includes the step of establishing a joint interaction arena (JIA) as a bounded subspace of the computing device's control space. The computing device in this example is a tablet, where the control space (touch area) and the display space (screen area) are tightly integrated to form a single touch screen. FIG. E2-1 depicts the control space 10, and the circular line 70 can be seen to enclose the area of a disk. The disk, which is a subspace of the control space 10 and which is bounded by the circle 70, is established as the JIA 800. When the user touches a point inside the JIA 800, it will have a joint interaction effect on the objects to be introduced.

The method also includes the step of establishing a fused threshold (FT) on the boundary of the JIA. The circle 70 forming the boundary of the JIA 800 is divided in this example into 24 contiguous and non-overlapping segments 70.i, where i ranges from 1 to 24. The segments 70.4 and 70.21 are explicitly labelled in FIG. E2-1. The 24 segments 70.1 to 70.24 together form the FT 70, which is graphically indistinguishable from the circle 70. The JIA 800 and the FT 70 together form a single JIA+FT control mechanism.

The joints 700.i between the segments are also shown, with the joints 700.4, 700.5 and 700.21 explicitly labelled.

The method also includes the step of establishing a relation between the FT segments and a plurality of objects. Each of the 24 FT segments 70.i in this example is associated with a data object represented in the computer memory. These data objects may for example be files containing images, text, music or programs. The objects may therefore also represent actions like playing a song or editing a document. The association in this example is a one to one relation between the FT segments 70.i and the data objects.

The method also includes the step of displaying representations of at least two of the objects. The 24 small black discs 84.i on the circle 70 in FIG. 2-1 are inverse mappings of the object representations in display space, to the control space depicted in the figure. The arrangement of objects in display space is suggested, but not shown directly.

The method also includes the step of receiving user input relative to the JIA and the FT. The user input in this example is the point of touch 40 on the touch screen 10 at any instant in time. The point of touch 40 is then interpreted in a continuous way with respect to the JIA 800, but in a discrete way with respect to the FT 70.

The continuous interpretation of the user input 40 with respect to the JIA 800 in this example involves continuous changes in the positions of the object representations 84.i, and a reflexive continuous change to the single control mechanism itself. The discrete interpretation of the user input 40 with respect to the FT 70 involves triggering the action associated with the object 84.i, when the user touch point crosses the FT 70 at segment 70.i.

The situation reflected in FIG. 2-1 corresponds to a user touch point 40 at the centre point 60 of the JIA+FT control mechanism. The method also includes the step of changing the JIA and/or the FT and/or the display whenever the relevant user input changes. In this example, two of the three elements mentioned in the step are changed, namely the display and the FT.

When the user touch point 40 moves in the general direction of object 84.21, two effects can be observed, as shown in FIG. E2-2. Firstly, the display positions of the objects have moved on the circle, away from 84.21, with some like 84.9 and 84.10 having disappeared completely.

Secondly, the joints 700.i of the FT 70 have moved, enlarging the control space of segment 84.21 and its neighbours, and shrinking that of the ones that disappear. The joints at the point furthest from 70.21 are made to coincide, eliminating control space from the associated objects. Elements of the user touch point trajectory are retained in memory, allowing hysteresis and the associated advantage in motor space for the control functions of some objects.

Both of these effects result from continuous interaction between the user touch point 40 and the JIA 800. It is also possible to trigger a discrete event at a given line inside the JIA, but the current style of interaction tends towards deferred discretization.

FIG. E2-3 illustrates the discrete interaction between the user touch point 40 and the FT 70. It shows the instant where the user touch point 40 has reached the segment 70.21 associated with object 21 triggering its associated action.

### EXAMPLE 3

### Distorting the Fused Threshold Into an Ellipse

In the third example of the invention, the method for human computer interaction (HCI) on a graphical user interface (GUI) is used primarily to distort the fused threshold of the control mechanism from an initial circle into a symmetric ellipse, thereby speeding up the process of interaction.

In this example three steps of the method, namely the ones establishing a JIA, establishing an FT and establishing a relation between the FT segments and the objects, are carried out in exactly the same way as before. The steps of displaying object representations and of receiving user input is also no different here. The part of Example 1 covering these five steps is therefore incorporated here by reference, rather than repeated. Refer therefore to FIG. E1-2 which shows the display space 14 of the device, when the user touch point 40 is at the centre point 60 of the JIA+FT control mechanism. In this example, as before, the user input is interpreted in a continuous way with respect to the JIA 800, but in a discrete way with respect to the FT 70.

The main difference between this example and the previous ones lies in the performance of the step of changing the JIA and/or the FT and/or the display whenever the relevant user input changes. In this example, all three the mentioned elements are changed.

When the user touch point 40 moves in the general direction of object 84.8, two effects can be observed, as shown in FIG. E3-1. Firstly, the display sizes of all the objects have changed, with 84.8 growing and 84.4 in the opposite direction shrinking, and the rest interpolating the effect.

Secondly, the shape of the FT 70 has changed from circular to elliptical, with the minor axis aligned with the displacement of the user touch point 40 from its initial contact position. The flattening of the circle into an ellipse has the effect of bringing both the control segment 70.8 and the display object 84.4 closer to the user point 40, speeding up the interaction. Because the JIA 800 is bounded by the FT 70, its outline and shape changes along with the FT.

The changes in the control space and the display space both result from the continuous interaction between the user touch point 40 and the JIA 800. It is also possible to trigger a discrete event at a given line inside the JIA, but the current style of interaction tends towards deferred discretization.

FIG. E3-2 illustrates the discrete interaction between the user touch point 40 and the FT 70. It shows the instant where the user touch point 40 has reached the segment 70.8 associated with object 8, triggering its associated action.

This example shows that it is possible to distort the JIA+FT control mechanism from a circular to an elliptical shape. It is important for user feedback that this distortion can be performed continuously, without any sudden changes in the shape of the mechanism. The visual effect is that of seeing a single object metamorphosing, i.e. changing shape without losing its identity.

The initial shape of a circle is particularly suited to objects for which the user's initial degrees of interest (DoI) are the same. If the a priori values of DoI are not equal, another shape may better reflect the situation. The method is not limited to either circular starting shapes or elliptical final shapes, but can be adapted according to a priori information and preferences.

### EXAMPLE 4

### Distorting the Fused Threshold Into a Cardioid

In the fourth example of the invention, the method for human computer interaction (HCI) on a graphical user interface (GUI) is used primarily to distort the fused threshold of the control mechanism from an initial circle into an asymmetric cardioid, thereby speeding up the process of interaction.

In this example three steps of the method, namely the ones establishing a JIA, establishing an FT and establishing a relation between the FT segments and the objects, are carried out in exactly the same way as before. The steps of displaying object representations and of receiving user input is also no different here. The part of Example 1 covering these five steps is therefore incorporated here by reference, rather than repeated. Refer therefore to FIG. E1-2 which shows the display space 14 of the device, when the user touch point 40 is at the centre point 60 of the JIA+FT control mechanism. In this example, as before, the user input is interpreted in a continuous way with respect to the JIA 800, but in a discrete way with respect to the FT 70.

The main difference between this example and the previous ones lies in the performance of the step of changing the JIA and/or the FT and/or the display whenever the relevant user input changes. In this example, all three the mentioned elements are changed.

When the user touch point 40 moves in the general direction of object 84.8, two effects can be observed, as shown in FIG. E4-1. Firstly, the display sizes of all the objects have changed, with 84.8 growing and 84.4 in the opposite direction shrinking, and the rest interpolating the effect.

Secondly, the shape of the FT 70 has changed from circular to cardioid, with the cusp aligned with the direction in which the user touch point 40 is moving. The continuous deformation of the circle into a cardioid has the effect of bringing both the control segment 70.8 and the display object 84.8 closer to the user point 40, speeding up the interaction. Because the JIA 800 is bounded by the FT 70, its outline and shape changes along with the FT.

The changes in the control space and the display space both result from the continuous interaction between the user touch point 40 and the JIA 800. It is also possible to trigger a discrete event at a given line inside the JIA, but the current style of interaction tends towards deferred discretization.

FIG. E4-2 illustrates the discrete interaction between the user touch point 40 and the FT 70. It shows the instant where the user touch point 40 has reached the segment 70.8 associated with object 8, triggering its associated action.

FIG. E4-3 is based on different parameters from those used in the previous two figures, in order to show more clearly the cardioid shape of the FT.

This example shows that it is possible to distort the shape of the JIA+FT control mechanism from a circular to a cardioid shape. The asymmetric nature of the cardioid is particularly suited to an interaction favouring a single object, and is superior to the ellipse in this respect, because the ellipse flattens also in the direction from which the user is receding. Again, it is important that it is possible to parametrically change a circle continuously into a cardioid, so as not to disturb the user's perception of interacting with a single persistent object consisting of a plurality of parts.

### EXAMPLE 5

### Moving the Centre of the Control Mechanism While Distorting the Fused Threshold Into a Cardioid

In the fifth example of the invention, the method for human computer interaction (HCI) on a graphical user interface (GUI) is used to move the centre of the control mechanism while simultaneously distorting the fused threshold of the control mechanism from an initial circle into an asymmetric cardioid. The result is a synergy of techniques for speeding up the process of interaction.

In this example three steps of the method, namely the ones establishing a JIA, establishing an FT and establishing a relation between the FT segments and the objects, are carried out in exactly the same way as before. The steps of displaying object representations and of receiving user input is also no different here. The part of Example 1 covering these five steps is therefore incorporated here by reference, rather than repeated. Refer therefore to FIG. E1-2 which shows the display space 14 of the device, when the user touch point 40 is at the centre point 60 of the JIA+FT control mechanism. In this example, as before, the user input is interpreted in a continuous way with respect to the JIA 800, but in a discrete way with respect to the FT 70.

The main difference between this example and the previous ones lies in the performance of the step of changing the JIA and/or the FT and/or the display whenever the relevant user input changes. In this example, all three the mentioned elements are changed.

When the user touch point 40 moves in the general direction of object 84.8, two effects can be observed, as shown in FIG. E5-1: Firstly, the sizes of all the objects have changed, with 84.8 growing and 84.4 in the opposite direction shrinking, and the rest interpolating the effect.

Secondly, the centre of the JIA+FT control mechanism has moved in the direction opposite to the movement of the user touch point 40, while the shape of the FT has simultaneously changed from circular to cardioid, with the cusp aligned with the direction in which the user touch point 40 is moving. The two techniques contribute in a synergistic way to the effect of bringing both the control segment 70.8 and the display object 84.8 closer to the user point 40, speeding up the interaction.

The changes in the control space and the display space both result from the continuous interaction between the user touch point 40 and the JIA 800. It is possible to trigger a discrete event at a given line inside the JIA, but the current style of interaction tends towards deferred discretization.

FIG. E5-2 illustrates the discrete interaction between the user touch point 40 and the FT 70. It shows the instant where the user touch point 40 has reached the segment 70.8 associated with object 8, triggering its associated action.

This example shows that it is possible to distort the shape of the JIA+FT control mechanism from a circular to a cardioid shape simultaneously with moving its centre point. It illustrates that the separate techniques of Examples 1 and 4 may be combined in a mutually strengthening way. All the techniques illustrated and mentioned in the first four examples may be profitably combined, including moving the centre, moving the joints, distorting the shape in various ways and scaling of the JIA+FT control mechanism. These effects are all reflexive, in the sense that the control mechanism is used to change itself. Many other effects that change the display of objects may be added on top of them.

1. A method for human-computer interaction (HCI) on a graphical user interface (GUI), which method includes the steps of:
establishing a joint interaction arena (JIA) as a bounded connected subspace of the computing device's control space;
establishing a Fused Threshold (FT) on the boundary of the JIA;
establishing one or more interactive objects;
establishing a relation between one or more of segments of the Fused Threshold and the object(s);
displaying representations of at least two of the objects;
receiving user input relative to the JIA and the FT;
changing the JIA and/or the FT based on the user input whenever the relevant user input changes; and
displaying the effect of the changes on the displayed objects.

2. A method as claimed in claim 1, wherein the JIA is changed by changing any one or more of its position, shape and rules for its use.

3. A method as claimed in claim 1 or claim 2, wherein the FT is changed by any one or more of moving, scaling, rotating the FT as a whole, deformation of the FT, shifting or changing the FT fusion joints and adding or removing fusion joints.

4. A method as claimed in any one of claims 1 to 3, wherein the bounded subspace of the JIA is limited to a star shape with respect to the user point, throughout the interaction.

5. A method as claimed in any one of claims 1 to 4, which method takes into account user movements at earlier instants in time by tracking user movement to form a user trajectory in the control space.

6. A method as claimed in any one of claims 1 to 5, which method predicts future user movements.

7. A method as claimed in any one of claims 1 to 6, which method includes the step of interpreting the user input in a way that reflexively changes the way in which user input is interpreted.

8. A method as claimed in any one of claims 1 to 7, wherein JIA is a simply connected set.

9. A method as claimed in any one of claims 1 to 8, which method is reflexive in that the source and the target of control can both include the same thing.

10. A method as claimed in any one of claims 1 to 9, wherein the user input is received from an input device capable of sensing three dimensional movement.

11. A method as claimed in any one of claims 1 to 10, wherein more than one control mechanisms are established inside the same control space and interaction between the mechanisms are established.

12. A method as claimed in any one of claims 1 to 11, wherein, the inverse of the computing device's C-D function connecting the control space to the display space is used to derive bounds for the control space from the bounds of the display space.

13. A device for human-computer interaction (HCI) on a graphical user interface (GUI), which device includes:
a joint interaction arena (JIA) as a bounded connected subspace of the computing device's control space;
a Fused Threshold (FT) on the boundary of the JIA;
wherein a relation between the FT segments and a plurality of objects is established;
displayed representations of at least two of the objects;
a user input space for receiving user input relative to the JIA and the FT; and
wherein the device is configured to change the JIA and/or the FT and/or the display based on the user input whenever the relevant user input changes.

14. A continuous-discrete control mechanism, wherein the continuous part of the mechanism is configured to:
establish a joint interaction arena (JIA) as a bounded connected subspace of the computing device's control space;
establish a Fused Threshold (FT) on the boundary of the JIA;
establish one or more interactive objects;
establish a relation between one or more of segments of the Fused Threshold and the objects;
display representations of at least two of the objects;
receive user input relative to the JIA and the FT;
change the JIA and/or the FT based on the user input whenever the relevant user input changes; and
display the effect of the changes on the displayed objects;
and wherein the discrete part of the mechanism includes activating an action once the FT is crossed by a user.

15. A method for human-computer interaction (HCI) on a graphical user interface (GUI), substantially as described herein with reference to the accompanying drawings.

16. A device for human-computer interaction (HCI) on a graphical user interface, (GUI), substantially as described herein with reference to the accompanying drawings.

17. A continuous-discrete control mechanism, substantially as described herein with reference to the accompanying drawings.
